(19) United States
(12) Patent Application Publication
(10) Pub. No.: US 2004/0255807 A1
(43) Pub. Date: Dec. 23, 2004

(54) Method for designing and making window coverings by adopting on-demand digital printing technology

(76) Inventor: Shiyue Xiong, Arcadia, CA (US)

Correspondence Address: Shiyue Xiong, 1009 Arcadia Ave. Apt 21, Arcadia, CA, 91007, US

(21) Appl. No.: 10/857,769

(22) Filed: Jun. 1, 2004

Related U.S. Application Data
(60) Provisional application No. 60/476,820, filed on Jun. 9, 2003.

(51) Int. Cl. B41C 1/00

(52) U.S. Cl. 101/483

(57) ABSTRACT

The present invention is providing a method for designing and making window coverings by adopting the on-demand digital printing technology. The method comprises the steps of: A) make designs for surface decoration of the fabric of the window covering and a style of the window covering in a computer, B) cut the foundation fabrics ready for printing to fit a window or a door in size and to meet a shape of the window covering; C) review and modify the designs with professional skills including transform, color, zoom, re-arrangement, etc to best match the window covering; D) export the designs from the computer to a printer; E) print the designs on the cut foundation fabrics and then sew the printed fabrics together, or first sew the cut foundation fabrics together and then print the designs on the sewn foundation fabrics; F) finish off the window covering. Whereby the designs to specially match the window covering are printed on the foundation fabrics on-demand and the window covering with the special surface decorative designs is made. Using the method of the present invention can greatly satisfy the customers' need, and they may choose any picture, any image, any pattern, any cartoon, any color, any word or a logo of a business, even their own artworks or photographs for the surface decoration of the fabric. Also the method avoids wasting the fabric due to aligning the patterns, and the manufacturer of the window covering reduces the expense and the cost for stocking the fabrics with various patterns.

### CROSS-REFERENCE TO RELATED APPLICATION

This application claims the benefit of U.S. Provisional Application No. 60/476,820, filed Jun. 9, 2003.

### FIELD OF THE INVENTION

The present invention is related to a method for designing and making window coverings, especially to such a method for designing and making the window coverings by adopting on-demand digital printing technology.

### BACKGROUND OF THE INVENTION

Up to now, for a fabric of a window covering, regardless of the ready-made or the custom-made, its pattern and color have been pre-printed or pre-dyed by a manufacturer of the fabric, and once the fabric is finished, its pattern and color can't be changed. However, the pattern and the color provided by the manufacturer are always limited. This is because they have to mass-print and mass-dye to reduce the cost of the design, plate making and the film under the conventional printing and dyeing technology. On the other hand, what are printed on the existing fabric are ordinarily some patterns to be arranged in certain order, but not a whole art picture or a complete image, and this is because cutting will destroy the completion of the picture or the image in the process of making the window coverings or anything else. So, a customer's choice is very limited actually when he (she) decides to order the window covering, such as a drapery, a valance or a shade. It often occurs that the customer favors a certain pattern, but there is not a color he (she) likes, or he (she) favors a certain color but is not satisfied with its pattern, even more both the pattern and the color can not match his (her) room. The customer is disappointed because he (she) has not more choice. Here, the customer is very passive really. He (she) can't make any change in the pattern and the color of the fabric, and he (her) even can't put their good idea or their own artworks into the designs.

An on-demand digital printing technology provides a chance to solve the perplexing problem. Its remarkable merit is that anything we want to show, such as a pattern, a picture, an image, some words and a logo of a business, etc, may be designed in a computer first and modify time after time, and then they may directly be exported from the computer into a digital printer to print on-demand without the film, without plate making, and thus its cost is lower for little printing. This digital printing is especially fit for the little printing, even one-piece printing. Further, the customer himself may design and modify their works at any time before printing until he (she) is satisfied with everything.

Unfortunately, the advanced digital printing is not developed in the business field of the window treatment. Maybe the conventional concept holds that the window coverings are made of the fabrics, but the pattern and the color of the fabrics are certainly pre-printed and pre-dyed, and the pre-printed pattern and pre-dyed color are unable to be changed. The fundamental idea of the present invention is that it is not certain that the pattern and the color of the fabric must be pre-printed and pre-dyed, and the pattern may be changed in shape, size, color and arrangement, and any pattern of the fabric may instantly be printed “on-demand”, and any artwork, any image, any word can completely be printed on the surfaces with various shapes and sizes, and be fully shown without disfigurement. The present invention remedies the defect of the conventional technology for the window coverings by adopting the on-demand digital printing technology. The present invention innovates in the method for making the window coverings in substance.

### OBJECTS AND ADVANTAGES

The present invention has at least the following advantages:

1. The customers' choices are expanded greatly, and their choices should no longer be limited to the pattern and the color of the fabric provided by a manufacturer, and they may choose anything they prefer, such as any art picture, any image, any pattern, any color, or any word, and really realize “what you get is what you want”, thus using the method of the present invention can greatly satisfy the customers' need, and a designer can bring his (her) creativity and inspiration into play without any restraint for designing the window coverings.

2. The present invention provides the customers with a chance to show their own artworks and designs for making the window coverings. The present invention should transform the customer from a passive receiver to an active participator of the design. The participation of the customer should greatly enhance the expressing power of the window covering, and make the window covering fully show individual character, but at present, the window coverings of this home is often similar to one of another home because the existing window coverings come out of the limited resource of the fabric.

3. The customer can save money. We often sew several pieces of the fabrics together in making the window coverings. Under the conventional technology to align the pattern or to arrange the pattern as desired in the sewing process we have to cut off a portion of the fabric. Some fabric is wasted. There is no such waste if to adopt the method of the present invention because the pattern or the picture have well been aligned and arranged as desired to fit the cut and sewed foundation fabric before printing in the computer and should completely be printed on the cut and sewed foundation fabric, but only a little of foundation fabric is cut off for the shape of the window covering.

4. The manufacturer of the window covering can save the cost too, because if it adopts the method of the present invention it should no longer need to stock the more fabrics with various patterns (at least to reduce the stock), and thus reduce the expense of a warehouse and the cost of the stocked fabrics, also reduce the expense of delivery of the fabric and save time. Sometimes to order the certain fabric spends much time for delivery between two cities.

5. By using the method of the present invention the customer and the designer may review their designs over and over again in the computer and may modify them at any time before printing, so they can get a satisfying result and avoid an unhappy dispute.

6. Because many significant images, blessing words and even a signature may be printed on the fabric of the window covering by using the method of the present invention the window covering will not only have a practical function, but also it will become a very good commemorative gift, and because a logo of a business or an advertising may be printed on it, it will become a very good medium of the advertising.

### BRIEF SUMMARY OF THE INVENTION

The present invention is providing a method for designing and making window coverings by adopting the on-demand digital printing technology. The method comprises the steps of: A) make designs for surface decoration of the fabric of the window covering and a style of the window covering in a computer, B) cut the foundation fabrics ready for printing to fit a window or a door in size and to meet a shape of the window covering; C) review and modify the designs with professional skills including transform, color, zoom, re-arrangement, etc to best match the window covering; D) export the designs from the computer to a printer; E) print the designs on the cut foundation fabrics and then sew the printed fabrics together, or first sew the cut foundation fabrics together and then print the designs on the sewn foundation fabrics; F) finish off the window covering. Whereby the designs to specially match the window covering are printed on the foundation fabrics on-demand and the window covering with the special surface decorative designs is made. Using the method of the present invention can greatly satisfy the customers' need. The customers' choice is expanded greatly, and their choice should no longer be limited to the pattern and the color to be provided by a manufacturer, and they may choose any picture, any image, any pattern, any cartoon, any color, any word or a logo of a business, even their own artworks or photographs. Also the method avoids wasting the fabric due to aligning the patterns, and the manufacturer of the window covering reduces the expense and the cost for stocking the fabric with various patterns.

### DRAWING FIGURES

FIG. 1 shows a piece of fabric with a pattern.

FIG. 2 shows a style of a valance.

FIG. 3 shows a valance with a sunflower printed on every arc unit.

FIG. 4 shows a valance with a big sunflower printed on every arc unit.

FIG. 5 shows a valance with a picture of a pet printed on every unit.

FIG. 6 shows a window roller shade made of the fabric with the pattern.

FIG. 7 shows a roller shade on which a completed picture is printed.

### DESCRIPTION OF THE PREFERRED EMBODIMENT

The method of the present invention is described as follows:

1. Make designs for surface decoration of the fabrics of window coverings and its style in a computer. Once a customer decides to order a window covering, such as a drapery, a valance or a window shade, first, the customer and a designer should make the designs for the window covering according to the condition of a room and the customer's taste. They should no longer limit their choice only to the pattern and the color of the fabric offered by a manufacturer, and they may have more choice by adopting the method of the present invention. They may get creative material from their own drawing, photography, or by scanning any material they like, such as an artwork, an image, a cartoon, some words or a logo of a business, as their creative resource.

2. Cut the foundation fabrics ready for printing to fit a window or a door in size and to meet a shape of the window covering.

3. Review and modify the designs with professional skills including transform, color, zoom, re-arrangement, etc to best match the window covering.

4. Export the designs from the computer to a printer after the customer is satisfied with everything of the designs.

5. Print the designs on the cut foundation fabric and then sew the printed fabrics together, or first sew the cut foundation fabrics together and then print the designs on the sewn foundation fabric.

6. Finally, finish off the window coverings.

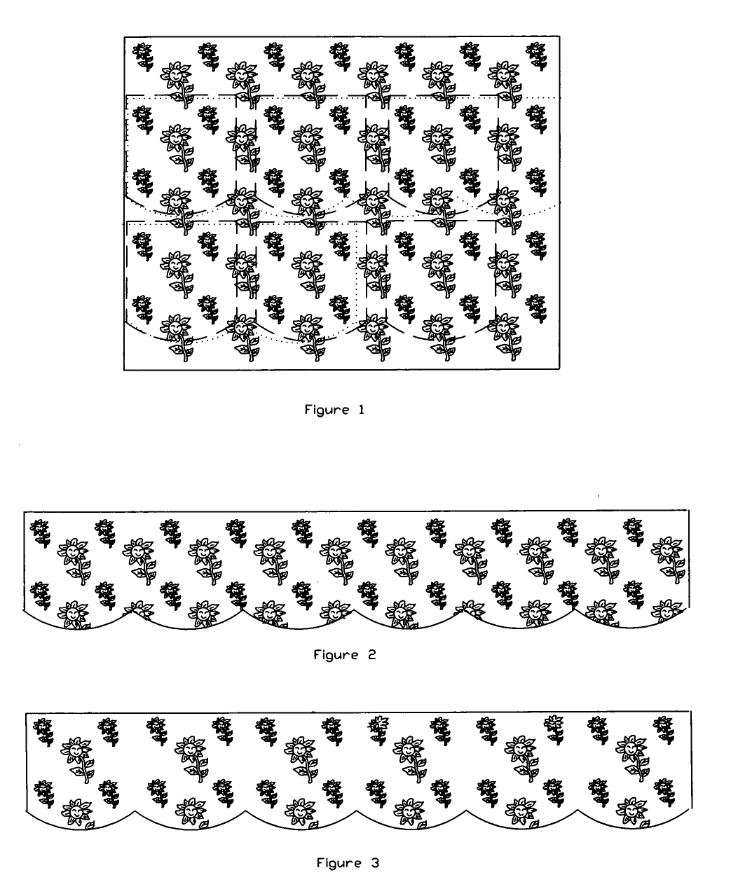

We cite the following example in further illustration of the method of the present invention. FIG. 1 shows a piece of the fabric with a pattern. Suppose the customer wants to order a valance and picks the fabric shown in FIG. 1 and the style shown in FIG. 2. Because the width of the valance is more than the width of the fabric we have to sew several pieces of the fabrics together to fit the width of the valance. Under the conventional technology, we can make this valance by using two different ways.

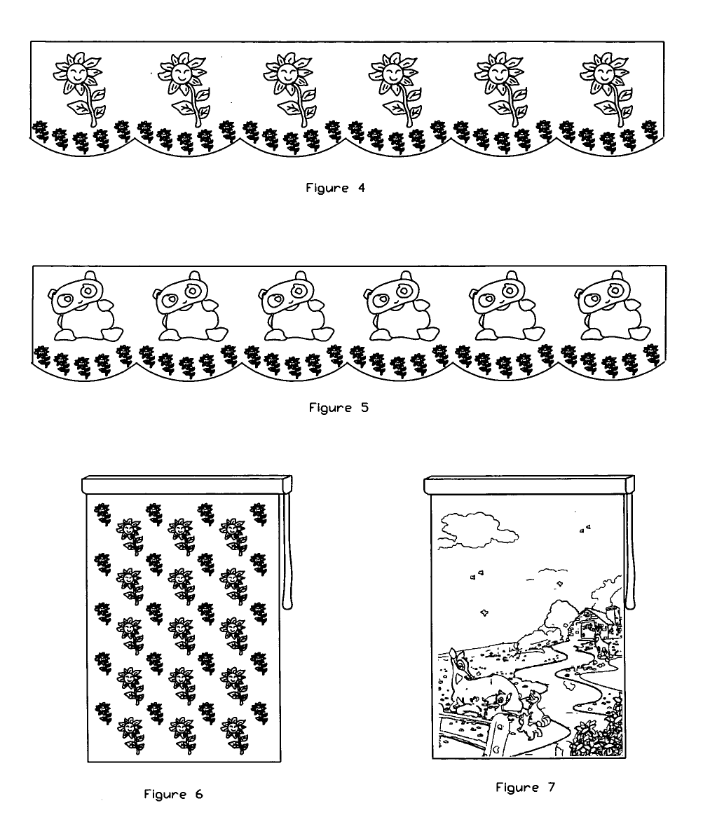

In way 1, we can cut out two pieces of the fabric in the shape of the valance as indicated by the dot contour of FIG. 1, and then sew the two pieces of the cut fabrics together to reach the width of the valance. FIG. 2 shows the valance completed by above steps. We can find in FIG. 2 that the pattern of the valance still keeps its original order and arrangement. However, the customer doesn't like it. He (she) complains the arrangement of the pattern doesn't fit the shape of the valance. Let us discuss in the concrete, if we divide the valance into some units on the basis of the bottom arcs of the valance, a big sunflower appears just in the center of each of unit 1 and unit 4 beginning from the left, but no big sunflower is just in the center of each of the other units, and it looks disordered. He (she) hopes that there is the big sunflower just in the center of every unit. To do so, let us do the valance by the steps of way 2 below. We should cut six units out of the fabric and make every unit have the big sunflower in its center. The dashed contour of FIG. 1 shows such six units, (only six units meet the requirement that the big sunflower is just located in the center of the unit, no more can be cut out of this piece of the fabric), and then sew the six units together to make up the valance, see FIG. 3. In the two ways above, in order to align the pattern, at least 30 percent of the fabric is cut off, and the waste in way 2 is more than one in way 1. In FIG. 3, we see the pattern has fitted the shape of the valance, namely one big sunflower is just located in the center of every unit. However the customer is still dissatisfied with it. He (she) thinks that the big sunflower is too small to fill the unit fully, but we can do nothing under the conventional technology because we can't change the pre-printed patterns. Using the method of the present invention, everything becomes very easy, and nothing is what we can't do. Assume the customer still chooses this fabric, but hopes that the sunflower is big enough to fill up the unit and some small sunflowers are put along the bottom edge. The first thing we should do is to scan the pattern and the color of the fabric into the computer; next enlarge and copy the sunflowers to fill up every unit, and reduce the sunflowers and arrange the reduced sunflowers along the arc bottom edge; and then cut the foundation fabrics in the shape of the valance; finally print the rearranged sunflowers on the surface of the cut foundation fabrics. Refer to FIG. 4. If the customer prefers to put a picture of his (her) pet on the valance, good idea, we can do that, simply to replace the big sunflowers with the pictures of the pet. Refer to FIG. 5.

Now let us discuss another instance of the window roller shade. The most existing roller shades are made of the fabric with or without the patterns. Because the shades usually are flat some customers often complain that the shade looks like a piece of the fabric to be hanged on the window temporarily. See FIG. 6. If we print an image, a landscape or their own art works they like on the shade instead of the dull pattern, see FIG. 7, that is really out of the ordinary, and its individual character will be shown fully.

I claim:

1. A method for designing and making a window covering by adopting on-demand digital printing technology, comprising the steps of:
a) making designs for surface decoration of fabrics of said window covering and a style of said window covering in a computer, and
b) cutting the foundation fabrics ready for printing to fit a window or a door in size and to meet a shape of said window covering, and
c) reviewing and modifying said designs with professional skills including transform, color, zoom, re-arrangement, etc to best match said window covering, and
d) exporting said designs from said computer to a printer, and
e) printing said designs on the cut foundation fabrics and then sewing the printed fabrics together, or first sewing said cut foundation fabrics together and then printing said designs on the sewn foundation fabrics, and
f) finishing off said window covering,
whereby said designs to specially match said window covering are printed on said foundation fabrics on-demand and said window covering with the special surface decorative designs is made.
